(19) United States
(12) Patent Application Publication
(10) Pub. No.: US 2024/0109751 A1
(43) Pub. Date: Apr. 4, 2024

(54) SOLUTION FOR CONTROLLING PASSENGER FLOW

(71) Applicant: KONE Corporation, Helsinki (FI)

(72) Inventors: Markku KAKKO, Helsinki (FI); Janne SORSA, Helsinki (FI); Salla MANNERJOKI, Helsinki (FI)

(73) Assignee: KONE Corporation, Helsinki (FI)

(21) Appl. No.: 18/541,895

(22) Filed: Dec. 15, 2023

Related U.S. Application Data
(63) Continuation of application No. PCT/EP2021/066227, filed on Jun. 16, 2021.

(51) Int. Cl. B66B 1/46; B66B 1/06; B66B 3/00

(52) U.S. Cl. CPC B66B 1/468; B66B 1/06; B66B 3/002; B66B 1/3476; B66B 2201/102; B66B 2201/103; B66B 2201/211; B66B 2201/216; B66B 2201/403; B66B 2201/4615

(57) ABSTRACT

In a method for allocating an elevator in an elevator system, the elevator system including elevator groups, each group including elevators, the elevator groups being formed based on a load unbalance of the elevators, the method includes: detecting received service calls in a predefined time window; evaluating a number of passengers requesting service based on the received number of service calls; selecting, based on the evaluated number of passengers, an elevator group to serve the floor; and allocating an elevator belonging to the selected elevator group to provide service. An apparatus, an elevator system, and a computer program are also disclosed.

### CROSS REFERENCE TO RELATED APPLICATIONS

This application is a Continuation of PCT International Application No. PCT/EP2021/066227, filed on Jun. 16, 2021, which is hereby expressly incorporated by reference into the present application.

### TECHNICAL FIELD

The invention concerns in general the technical field of elevators. More particularly, the invention concerns a solution for serving passengers by an elevator system.

### BACKGROUND

Elevator allocation is an important operation in elevator systems in terms of service quality and user satisfaction. In traditional elevator systems in which a passenger provides a service call with a call giving button an elevator controller generates a control signal to the elevator system to accomplish the service call and as a result an elevator car arrives at a floor from which the service call was given by the passenger requesting service from the elevator system. The traditional mechanism works well especially in buildings being small and not having too many floors, which means that elevator resources are quite small, e.g. there is only one elevator serving the passengers.

In large buildings the service calls may be given so that a destination floor is provided in the service call. In other words, the elevator system comprises a service call giving interface residing e.g. at a lobby through which the passenger provides the destination where he/she wants to travel with the elevator, i.e. the destination floor as mentioned. The elevator controller performs an allocation of an elevator car to serve the service call i.e. the passenger, which is then indicated to the passenger in one way or another. For example, the elevator system may indicate the elevator to the passenger through the service call giving interface, e.g. by displaying an identifier of the elevator among a plurality of elevators belonging to the elevator system so that the passenger may look for the identifier from the floor, or hall, area e.g. illustrated on a wall. Alternatively, the elevator system may just inform the passenger to take the next elevator indicated to travel upwards/downwards.

In some elevator system the elevator allocation by the elevator controller is aimed to be postponed until the last moment to perform the allocation so as to allow the elevator system a freedom to optimize the resources in the most appropriate way.

However, the existing solutions may not serve the passengers optimally. For example, in especially large buildings the waiting area, such as the lobby, layout may be large and complex which may cause frustration to passengers to find a suitable elevator among a plurality of elevators to serve him/her. This is especially true because the elevator is allocated, or selected, at the last moment in time for the reasons given above. These challenges are tried to be solved by grouping the elevators so that certain elevators e.g. locating closely to each other are arranged to serve certain floors whereas other closely located elevators are arranged to serve other floors.

A document EP 3188996 B1 discloses an elevator group comprising a first and a second elevator having differing counter-weight balances, wherein the counter-weight balances are taken into account in an allocation of the elevators to destination calls.

The grouping of elevators has potential to serve the passengers in a more satisfied way and, therefore, there is a need to introduce more sophisticated solutions inside the grouping approach which may also allow energy saving among other advantages in operating the elevator system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, an apparatus, an elevator system, and a computer program for allocating an elevator to provide service The objects of the invention are reached by a method, an apparatus, an elevator system, and a computer program as defined by the respective independent claims.

According to a first aspect, a method for allocating an elevator to provide service is provided, the elevator system comprising a number of elevator groups, each group comprising a number of elevators, the elevator groups are formed based on a load unbalance of the elevators, the method comprises:
detecting a number of received service calls in a predefined time window, the detected service calls being indicative on that service is re-quested to a floor,
evaluating a number of passengers requesting service based on the received number of service calls in the predefined time window,
selecting an elevator group among the plurality of the elevator groups to serve the floor, the elevator group is selected based on the evaluated number of passengers requesting service, and
allocating an elevator belonging to the selected elevator group to the floor to provide the service.

The evaluation of the number of passengers requesting the service may comprise: grouping the received service calls based on a detection that the received service calls comprise at least a common portion in a travel path departing from the floor. For example, a decision of the common portion of the travel path between the service calls may be made based on a direction of a travel indicated in the service calls.

Moreover, the evaluation of the number of passengers requesting the service may be performed by summing up the number of passengers indicated by the number of service calls.

The elevator group may also be selected among the plurality of the elevator groups by matching information indicative of a weight of the evaluated number of passengers with an information on the load unbalance of the elevators of the elevator groups.

The matching may e.g. comprise:
comparing information indicative of the weight of the evaluated number of passengers with the information on the load unbalance of the elevators of the elevator groups, and
selecting the elevator group formed by elevators having a load unbalance minimizing a difference in the comparison of information indicative of a weight of the evaluated number of passengers with the information on the load unbalance of the elevators of the elevator groups.

The method may further comprise generating an indication informing at least the selected elevator group through a user interface the service call is received.

According to a second aspect, an apparatus for allocating an elevator in an elevator system to provide service is provided, the elevator system comprising a number of elevator groups, each group comprising a number of elevators, the elevator groups are formed based on a load unbalance of the elevators, the apparatus comprising:
at least one processor; and
at least one memory including computer program code;
the at least one memory and the computer program code configured to, with the at least one processor, cause the apparatus to:
   detect a number of received service calls in a predefined time window, the detected service calls being indicative on that service is requested to a floor,
   evaluate a number of passengers requesting service based on the received number of service calls in the predefined time window,
   select an elevator group among the plurality of the elevator groups to serve the floor, the elevator group is selected based on the evaluated number of passengers requesting service, and
   allocate an elevator belonging to the selected elevator group to the floor to provide the service.

The apparatus may be configured to perform the evaluation of the number of passengers requesting the service by: grouping the received service calls based on a detection that the received service calls comprise at least a common portion in a travel path departing from the floor. For example, the apparatus may be configured to make a decision of the common portion of the travel path between the service calls based on a direction of a travel indicated in the service calls.

Moreover, the apparatus may be configured to perform the evaluation of the number of passengers requesting the service by summing up the number of passengers indicated by the number of service calls.

The apparatus may also be configured to select the elevator group among the plurality of the elevator groups by matching information indicative of a weight of the evaluated number of passengers with an information on the load unbalance of the elevators of the elevator groups.

The apparatus may be configured to perform the matching by:
comparing information indicative of the weight of the evaluated number of passengers with the information on the load unbalance of the elevators of the elevator groups, and
selecting the elevator group formed by elevators having a load unbalance minimizing a difference in the comparison of information indicative of a weight of the evaluated number of passengers with the information on the load unbalance of the elevators of the elevator groups.

According to a third aspect, an elevator system is provided, the elevator system comprising the apparatus according to the second aspect as defined above.

According to a fourth aspect, a computer program is provided, the computer program comprising computer readable program code configured to cause the apparatus according to the second aspect as defined above to perform the method according to the first aspect as defined above when said program code is run by the apparatus.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an elevator system according to an example.

FIG. 2 illustrates schematically a method according to an example.

FIG. 3 illustrates schematically an apparatus according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

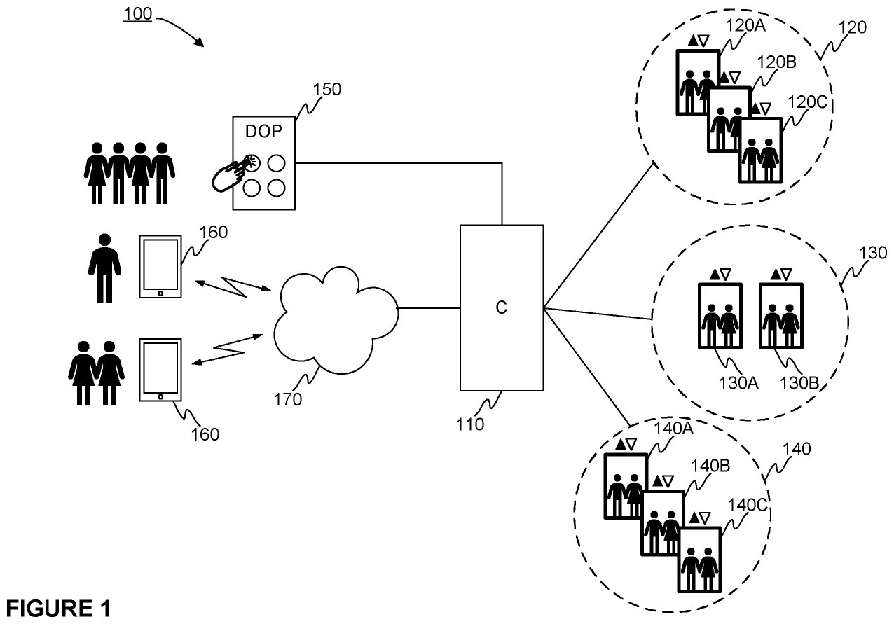

FIG. 1 illustrates schematically an elevator system 100 suitable for implementing a solution in accordance with the present invention. The elevator system 100 may comprise a group controller 110 configured to control elevator groups 120, 130, 140. The elevator groups 120, 130, 140 may comprise a number of elevators i.e. one or more elevators in each group 120, 130, 140 and, hence, the group controller 110 may be configured to control the elevators in the groups 120, 130, 140. The elevators in each elevator group 120, 130, 140 are denoted in FIG. 1 with 120A, 120B, 120C; 130A, 130B; 140A, 140B, 140C, respectively. The number of elevators 120A, 120B, 120C; 130A, 130B; 140A, 140B, 140C in each elevator group 120, 130, 140 is one or more and the number of elevator groups 120, 130, 140 is not anyhow limited to. The elevators 120A, 120B, 120C; 130A, 130B; 140A, 140B, 140C, in the groups, are implemented with a counter-weight based hoisting technology wherein each elevator 120A, 120B, 120C; 130A, 130B; 140A, 140B, 140C has its own counter-weight connected with a rope or a belt or similar to an elevator car over a traction sheave. The traction sheave is controlled by a hoisting machine by providing force to the traction sheave to move the elevator car, and, hence, the counter-weight along the path the respective elevator is arranged to operate. For sake of clarity, the present invention is also applicable in an elevator system which comprises a plurality of groups each comprising a number of elevators wherein the elevators are divided to sub-groups within the group. Terminologically this may mean that the term group used herein may have been called as a sub-group and the elevator system may correspond to an elevator group.

In accordance with the present invention the elevators 120A, 120B, 120C; 130A, 130B; 140A, 140B, 140C are classified to groups 120, 130, 140 on a basis of a load unbalance. The load unbalance refers herein to a weight difference between the elevator car and its counter-weight. The weight of the elevator car comprises at least the weight of the elevator car structure itself, but in addition it may also comprise weights of the car doors and a car sling. Also in some situations the weight of the elevator ropes may e.g. be divided between the elevator car and the counter-weight. In any case the weight unbalance is determined without any payload related estimation, or absolute value, and the determination is done in a similar manner for each elevator 120A, 120B, 120C; 130A, 130B; 140A, 140B, 140C. For sake of completeness, the term payload means passengers possibly with their goods, and any load brought in the elevator car. As mentioned in the foregoing description, the elevators 120A, 120B, 120C; 130A, 130B; 140A, 140B, 140C may be classified in the groups 120, 130, 140 and it is performed based on the load unbalance of the elevators 120A, 120B, 120C; 130A, 130B; 140A, 140B, 140C. In other words, elevators 120A, 120B, 120C; 130A, 130B; 140A, 140B, 140C to each group are selected on a basis of the load unbalance so that elevators 120A, 120B, 120C; 130A, 130B; 140A, 140B, 140C having the same load unbalance, or being within pre-defined range, are assigned to the same group 120, 130, 140. As a result, the elevators 120A, 120B, 120C; 130A, 130B; 140A, 140B, 140C of the elevator system 100 belong to one of the groups 120, 130, 140. Depending on an implementation, the ranges of the load unbalance, may be pre-defined so that at least one elevator 120A, 120B, 120C; 130A, 130B; 140A, 140B, 140C is assigned to each group 120, 130, 140. One of the groups 120, 130, 140 may be defined so that it receives all the elevators 120A, 120B, 120C; 130A, 130B; 140A, 140B, 140C not belonging to any other group 120, 130, 140. In view of the above it is worthwhile to mention that the elevator cars in the elevators 120A, 120B, 120C; 130A, 130B; 140A, 140B, 140C are not necessarily the same in weight and the counter-weights may be selected for each elevator in accordance with the design and their difference in weight generates the load unbalance as described in the foregoing description.

The grouping of the elevators 120A, 120B, 120C; 130A, 130B; 140A, 140B, 140C in the described manner comprises an establishment of data structure defining the groups 120, 130, 140 so that information on the elevators 120A, 120B, 120C; 130A, 130B; 140A, 140B, 140C belonging to each elevator group 120, 130, 140 is derivable from the data structure. Additionally, it is possible to derive one or more definitions for the groups 120, 130, 140 from the data structure, the definitions comprising, but is not limited to, the load unbalance, or a range for the load unbalance, of the groups 120, 130, 140. The data structure may also define one or more devices of the elevators 120A, 120B, 120C; 130A, 130B; 140A, 140B, 140C, such as in relation to signaling devices, call control as well as user interfaces of the elevator entities of the elevators 120A, 120B, 120C; 130A, 130B; 140A, 140B, 140C, for example. The data structure may e.g. be maintained by the group controller 110, or any other entity used for managing the elevator system 100 in question, and the data structure may be stored in data storage accessible by the group controller 110.

The group controller 110 may be configured to have access to the data structure as described. Moreover, the group controller 110 may be arranged to, among other tasks, to perform an elevator allocation function to allocate an elevator group 120, 130, 140, and an elevator 120A, 120B, 120C; 130A, 130B; 140A, 140B, 140C therefrom, to serve one or more service calls received in the system. The service calls, typically expressed as destination calls, may be received from a number of sources in accordance with a design of the elevator system 100. The sources may refer to user interfaces implemented to the elevator system 100 so as to allow users of the elevator system i.e. passengers to indicate their service calls to the elevator system. One example of the interface may be a service call panel, such as a destination operating panel (DOP) 150. Such destination operating panels 150 may reside one or more at each landing, such as at lobbies, which may be used by users requiring a service from the elevator system 100. For example, the users may indicate a destination they want to travel, but also other parameters may be input, such as a number of persons requiring the same service or other desires to be applied in the provision of service, such as minimizing an energy consumption. Moreover, other user interfaces may be established to the elevator system 100, such as interfaces implemented with an application executed by a terminal device 160 carried by the user. Such terminal device 160 may be a mobile phone, a tablet computer, or a laptop computer, but the terminal devices are not limited to these. The application providing the user interface may be developed by the elevator company and allowed to be downloaded to the terminal device from an applicable server device, such as from an application store. The application may also provide a user interface allowing the user to input a destination for the service call, but also other parameters. The terminal devices 160, and the respective applications, may be configured to communication with the elevator system 100, and the group controller 110 over any applicable communication network 170, such as wireless communication network. For example, the wireless communication may be arranged over a wireless local area network, such as Wi-Fi, or over a mobile communication network in a manner commonly known from prior art.

In order to implement the method as described in the forthcoming description the group controller 110 may be configured to receive data descriptive of a location, such as data indicating a floor, to which the service from the elevator system 100 is requested. In case the applied interface is the destination operating panel 150, or any similar interface for inserting service calls, an identifier of the applied interface may be included in the signal to the group controller 110, which, in turn, may be configured to interpret the received piece of data for determining the respective source floor e.g. by inquiring the information from data storage storing the data mapping the identifier with a floor, or any other location. Alternatively or in addition, the data may directly include a floor number which may directly be applied by the group controller 110. In case, the user interface applied for giving the service call is a user terminal device 160 the location to which the service provision is requested may be provided with the application used for the service call if the application is configured so. Alternatively or in addition, any other mechanism may be applied to include, or to provide, the piece of data to the group controller 110 may be used. For example, any positioning system, such as indoor positioning system, known from prior art may be applied to determine the location of the terminal device 160 used for providing the service call. For example, the location, or the location data, obtainable from the applied positioning system may be included e.g. automatically by the application to the service request and, hence, delivered to the group controller 110 to be applied in manner as is described in the forthcoming description.

As is derivable from above and generally known an elevator system 100 is installable in a building. Such a building may, for example, be residential building, an office building, a public building, etc. The elevator system 100 may also be implemented to a location that is not necessarily considered as a building straightforwardly, such as an underground station of public transportation or another venue or place of interest that is offset from the ground level, or a marine vehicle, such as a cruise ship. In general, the elevator system 100 may be considered as a system arranged to serve passengers between a plurality of floors. The passengers may enter and exit the elevator cars from the respective floors also known as landings.

The present invention as such does not limit locations of the elevators with respect to other elevators in the same group 120, 130, 140, or in other groups 120, 130, 140. This may be understood so that independently from the locations the elevators, or at least part of them, under a control of the group controller 110 are involved in the operation. For practical reasons, the elevators are usually arranged close to each other enabling the entering and exiting the elevator cars of the elevators from the same landing area, such as from a lobby.

In the description it is assumed that any aspects related to a structure and operation of the one or more elevators of the elevator system 100, in general, may be provided using techniques known in the art and, consequently, any details pertaining to their structure and operation are described herein only to extent they are necessary for describing examples that pertain to allocating an elevator to serve the passengers which is in special focus of the present invention.

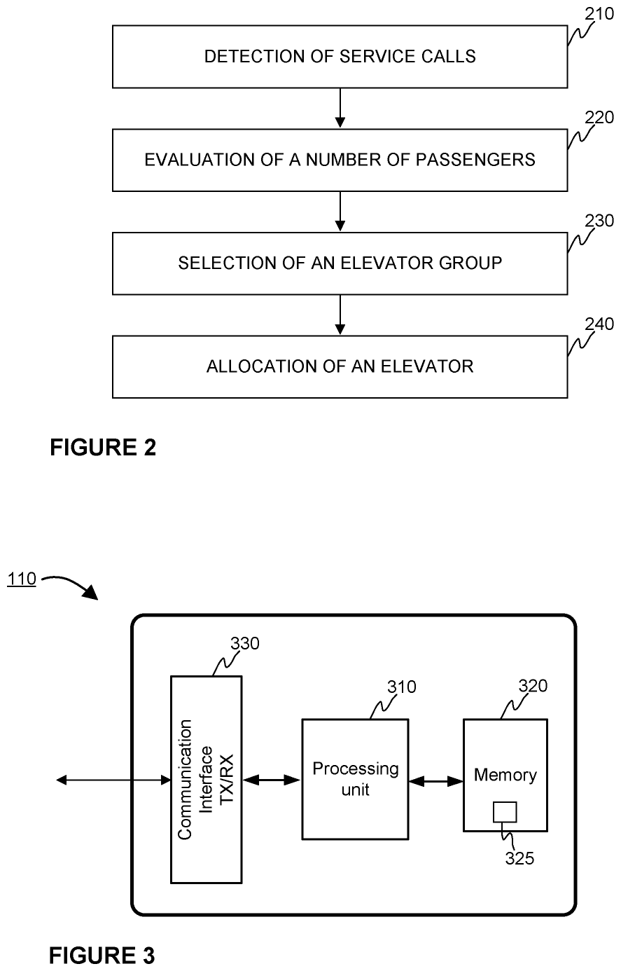

Next, at least some aspects of the present invention are described by referring to FIG. 2 schematically illustrating a method according to an example. The method is performed by a control controller 110 and is developed for allocating an elevator 120A, 120B, 120C; 130A, 130B; 140A, 140B, 140C in an elevator system 100 to provide service. As discussed in the foregoing description, the elevator system 100 comprises a number of elevator groups 120, 130, 140 wherein each group 120, 130, 140 comprises a number of elevators 120A, 120B, 120C; 130A, 130B; 140A, 140B, 140C and the elevator groups 120, 130, 140 are formed based on a load unbalance of the elevators 120A, 120B, 120C; 130A, 130B; 140A, 140B, 140C. A starting point is that the group controller 110 receives a number of received service calls in a predefined time window and the number of received service calls with the predefined time window are detected 210 by the group controller 110. The group controller is arranged to detect 210 the received service calls on a floor basis i.e., the detected service calls carry data indicative on that service is requested to a certain floor. As discussed earlier, the group controller 110 may receive the service calls from the user interfaces provided by the elevator system 100. For example, the predefined time window may be defined on a basis that acceptable service quality may be provided to the passengers with the elevator system 100 in question. Any other basis for defining the time window for the detection period may be applied to.

Next, the group controller 110 may be configured to perform an evaluation 220 on a number of passengers requesting service from the elevator system 100. The evaluation 220 may be performed based on the received number of service calls in the predefined time window for the floor in question. In other words, the group controller 110 may be configured to execute the evaluation process for each floor accessible with the elevator system 100 to evaluate the number of passengers on each floor who are waiting for a service from the elevator system 100. In order to perform the evaluation in an optimal way to eventually allocate an elevator to serve the service calls the evaluation also comprises a procedure in which the received service calls are grouped based on a detection that the received service calls comprise at least a common portion in a travel path departing from the floor in question. This corresponds at least that a direction of the travel is determined per the passenger(s) so as to generate an understanding on the travel direction of the number of passenger(s). The travel direction refers to either upwards or downwards dependent on a level of the floor. Hence, the common portion of the travel path may e.g. be defined from the input received from the user interface wherein the input may e.g. indicate a destination floor or at least a direction of the travel, for example. Now, the evaluation of the passengers waiting for the service may be performed by combining the information received in the service calls in a manner applicable to the received information in the context of calling the service. For example, the combining of information may comprise, but is not limited to, summing up the information indicative of the number of passengers on the floor under evaluation who want to travel to the same direction from the floor. The information indicative of the number of passengers may, hence, be collected from the different service calls. In the simplest implementation the group controller 110 may be configured to sum up the number of service calls received with the time window and indicating the same direction of the travel. This kind of approach is especially suitable in an example embodiment in which each service call is indicative on one passenger. In a more sophisticated solution the combining of information may comprise summing up all the information obtainable from the received service calls. Namely, in some example embodiments the service calls may carry information, e.g. by using dedicated parameters, in which it is defined the number of persons requiring the same service as the one who provided the service call in the elevator system 100 together with the information on the direction of the travel. This kind of approach may be implemented so that the user interface suitable for providing the service calls to the elevator system 100 prompts the user to provide information on the number of other passengers associated to the same service call. This kind of situation may e.g. occur when a number of persons leave the same meeting and head to the elevators at the same time to travel to other floors in a building and/or when a number of people concurrently arrives the building as a group and need elevator service. The combining of information may also comprise implementations in which further parameters, or similar, are taken into account with respect to the service calls. This may e.g. refer to any indication that the person in question, or the group of people, requires a service to travel alone, or among the group, in the elevator system 100, or that they want to have service saving energy in the system.

Next, the group controller 110 may be configured to select 230 an elevator group 120, 130, 140 among the plurality of elevator groups 120, 130, 140 to serve the floor to which the service calls under detection and evaluation relate to. The elevator group 120, 130, 140 may be selected 230 based on the evaluated number of passengers requesting the service to the same travel direction from the elevator system 100. In other words, the selection 230 may be directly performed on the basis of the information generated in the step of evaluation 220 wherein it is determined at least one passenger, or a number of passenger groups, to be served. The selection of the elevator group 120, 130, 140 may be performed so that the load unbalance of each of the elevator groups 120, 130, 140 is applied in the selection 230. The application of the load unbalance may be performed so that the group controller 110 evaluates a total weight of the passengers to whom the elevator allocation is performed with the method and performs a comparison with the load unbalance information so as to find an optimal elevator group 120, 130, 140 to serve the passengers. The evaluation of the total weight of the passengers may e.g. be performed by using an average weight of a passenger, or a person, and multiplying that value with the number of passengers to be served. Alternatively, the elevator system 100 may be prepared so that for each elevator group 120, 130, 140 it is defined an optimal number of passengers, or a range of passengers, as reference values, and by comparing the information on the number of passengers to the respective reference values the optimal elevator group 120, 130, 140 may be selected. The above provided rules for selecting the elevator group 120, 130, 140 to serve the floor the passengers reside are non-limiting examples and other approaches may also be applied to.

In response to the selection of the elevator group 230 the group controller 110 may be configured to allocate an elevator 120A, 120B, 120C; 130A, 130B; 140A, 140B, 140C belonging to the selected elevator group 120, 130, 140 to the floor to provide the service. The allocation of the elevator 120A, 120B, 120C; 130A, 130B; 140A, 140B, 140C may be based on any known allocation technique, such as by minimizing the waiting time of the passengers. According to another example, the allocation of the elevator 120A, 120B, 120C; 130A, 130B; 140A, 140B, 140C among the selected elevator group 120, 130, 140 may be implemented so that it is determined if one or more elevators 120A, 120B, 120C; 130A, 130B; 140A, 140B, 140C already carry load, such as passengers from earlier floors, and the allocation of the elevator 120A, 120B, 120C; 130A, 130B; 140A, 140B, 140C among the elevator group 120, 130, 140 may be performed by matching the available, or remaining, load resource of each elevator with the weight of passengers to be loaded from the floor in question so that the weight of the elevator car with the load with respect to the weight of the counter-weight is minimized. This kind of embodiment may be implemented so that the existing load in each elevator 120A, 120B, 120C; 130A, 130B; 140A, 140B, 140C in each group 120, 130, 140 is continuously maintained in the elevator system, such as by the controller 110 of the elevator system. Naturally, this kind of approach may also be configured to monitor an exit of passengers in the floors so as to allow maintenance of the information of the loads in real-time. Alternatively or in addition, the entity performing the allocation may receive the current load weights in the elevator cars 120A, 120B, 120C; 130A, 130B; 140A, 140B, 140C from applicable sensors, such as weight sensors, residing in the elevator cars 120A, 120B, 120C; 130A, 130B; 140A, 140B, 140C as known in prior art.

The signaling of information from the elevator system 110 to the passenger(s) requesting the service may be performed in a variety of ways. For example, in response to the receipt of the service call from a passenger through a user interface, the elevator system 100 may be configured to perform the steps referred with 210, 220, 230 in FIG. 3 and in the foregoing description, and generate a signal to inform the passenger through the user interface on the selected elevator group 120, 130, 140. The information may comprise further data, such as instructions on an optimal waiting area for the passenger(s) which may be provided to the passenger(s) over the user interface. Also, the information on the allocated elevator 120A, 120B, 120C; 130A, 130B; 140A, 140B, 140C may be provided to the passenger(s) over the user interface. Alternatively or in addition, the information on the allocated elevator 120A, 120B, 120C; 130A, 130B; 140A, 140B, 140C may be signaled to the passenger(s) in the waiting area, such as with the signaling devices, such as a lantern, of the allocated elevator 120A, 120B, 120C; 130A, 130B; 140A, 140B, 140C.

In the foregoing description it is mentioned that according to an example embodiment the service calls may carry further parameters by means of which the passenger(s) may provide additional requests to the elevator system 100. Such parameters may comprise information on that energy saving is requested from the elevator system 100 when providing the service to the service call. This kind of indication may cause the elevator system 100 to implement the selection of the elevator group 120, 130, 140 so that the number of passengers waiting for the service on the respective floor is defined for the time window and if it does not match with an optimal range for the closest group 120, 130, 140, the group controller 110 may be configured to extend the time window under evaluation so that the number of passengers may reach the optimal range of passengers defined for the elevator group 120, 130, 140 being the closest to serve the passengers. In the described manner it is possible to optimize an efficiency of the elevator system 100 so as to achieve energy saving in the elevator system 100. Naturally, as a trade-off the passenger(s) may need to wait the service for a bit longer period of time.

In the description above it is mentioned that the entity arranged to perform the method is a group controller 110. An example of an apparatus configurable to take a role of the group controller 110 is schematically illustrated in FIG. 3. For sake of clarity, it is worthwhile to mention that the block diagram of FIG. 3 depicts some components of an entity that may be employed to implement a functionality of the apparatus. The apparatus comprises a processor 310 and a memory 320. The memory 320 may store data, such pieces of data as described but also computer program code 325 causing the management of the maintenance in the described manner. The apparatus may further comprise a communication interface, such as a wireless communication interface or a communication interface for wired communication, or both. The communication interface may thus comprise one or more modems, antennas, and any other hardware and software for enabling an execution of the communication e.g. under control of the processor 310. The communication interface 330 may also comprise a portion implementing the communication interface towards the elevator groups 120, 130, 140, but also towards the user interfaces 150, 160 either directly or indirectly. Furthermore, I/O (input/output) components may be arranged, together with the processor 310 and a portion of the computer program code 325, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include out-put means, such as a loudspeaker, a display or a touchscreen. The components of the apparatus may be communicatively connected to each other via data bus that enables transfer of data and control information between the components.

The memory 320 and a portion of the computer program code 325 stored therein may further be arranged, with the processor 310, to cause the apparatus to perform at least a portion of a method for managing the maintenance as is described herein. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent/semi-permanent/dynamic/cached storage.

The computer program code 325 may comprise computer-executable instructions that implement functions that correspond to steps implemented in for allocating an elevator to a floor when the computer program code 325 is loaded into the processor 310 of the group controller 110 and executed therein. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform a method as explicitly described in the description herein. Hence, the apparatus may comprise at least one processor 310 and at least one memory 320 including the computer program code 325 for one or more programs, the at least one memory 320 and the computer program code 325 configured to, with the at least one processor 310, cause the apparatus to perform the method.

The computer program code 325 may be provided e.g. a computer program product comprising at least one computer-readable non-transitory medium having the computer program code 325 stored thereon, which computer program code 325, when executed by the processor 310 causes the apparatus 210, 120 to perform the method. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firm-ware or hardware adapted to or programmed to perform the necessary tasks.

The entity performing the method may also be implemented with a plurality of apparatuses, such as the one schematically illustrated in FIG. 3, as a distributed computing environment. For example, one of the apparatuses may be communicatively connected with other apparatuses, and e.g. share the data of the method, to cause another apparatus to perform at least one portion of the method. As a result, the method performed in the distributed computing environment generates the allocation of the elevator in the manner as described. Hence, the term apparatus shall be understood to correspond to a system in at least certain implementations of the invention.

Generally speaking, the invention as described herein by referring to disclosed examples improves an efficiency of an elevator system at least from a point of energy consumption since the allocation of the elevator to serve a service call is selected by matching the passengers with load unbalance of elevators so that energy consumption for moving the elevator is optimized. The improvement in the efficiency in operating an elevator system is especially true in large elevator systems having high travel paths and/or where the load unbalance is large due to an implementation of the elevator system, such as having so-called double deck cars. Further, since the elevator group, and the elevator, is selected so that the balancing is taken into account with respect to the load to be carried, less wear of components of the elevator system may be seen. Still further, the approach allows an improved management of the passengers, and passenger groups, which, in turn, allows controlling social distances between the passengers. Further advantages may also be seen in addition to ones mentioned herein.

For sake of clarity, the term elevator system into which the groups are formed in the manner as described may share common landing call devices, like call buttons or Destination Operating Panels (DOP) for allocating an elevator to provide service. As said, the elevators of the elevator system may be grouped in the described manner and they may have at least some common features or properties, like physical location, identifying signage/color/decoration, or is prepared for some specific use. The used terminology in the description herein may correspond to one in which the elevator system is called as an elevator group wherein the elevator group consists of a plurality of sub-groups corresponding to the term elevator group used in the description herein. It is directly derivable that the used terminology as such does not limit the scope of protection in any manner.

The specific examples provided in the description given above should not be construed as limiting the applicability and/or the interpretation of the appended claims. Lists and groups of examples provided in the description given above are not exhaustive unless otherwise explicitly stated.

1. A method for allocating an elevator in an elevator system to provide service, the elevator system comprising a number of elevator groups, each group comprising a number of elevators, the elevator groups being formed based on a load unbalance of the elevators,
the method comprising the steps of:
detecting a number of received service calls in a predefined time window, the detected service calls being indicative on that service is requested to a floor;
evaluating a number of passengers requesting service based on the received number of service calls in the predefined time window;
selecting an elevator group among the plurality of the elevator groups to serve the floor, the elevator group being selected based on the evaluated number of passengers requesting service; and
allocating an elevator belonging to the selected elevator group to the floor to provide the service.

2. The method of claim 1, wherein the evaluation of the number of passengers requesting the service comprises:
grouping the received service calls based on a detection that the received service calls comprise at least a common portion in a travel path departing from the floor.

3. The method of claim 2, wherein a decision of the common portion of the travel path between the service calls is made based on a direction of a travel indicated in the service calls.

4. The method of claim 1, wherein the evaluation of the number of passengers requesting the service is performed by summing up the number of passengers indicated by the number of service calls.

5. The method of claim 1, wherein the elevator group is selected among the plurality of the elevator groups by matching information indicative of a weight of the evaluated number of passengers with an information on the load unbalance of the elevators of the elevator groups.

6. The method of claim 5, wherein the matching comprises:
comparing information indicative of the weight of the evaluated number of passengers with the information on the load unbalance of the elevators of the elevator groups; and
selecting the elevator group formed by elevators having a load unbalance minimizing a difference in the comparison of information indicative of a weight of the evaluated number of passengers with the information on the load unbalance of the elevators of the elevator groups.

7. The method of claim 1, the method further comprises:
generating an indication informing at least the selected elevator group through a user interface the service call is received.

8. An apparatus for allocating an elevator in an elevator system to provide service, the elevator system comprising a number of elevator groups, each group comprising a number of elevators, the elevator groups being formed based on a load unbalance of the elevators,
the apparatus comprising:
at least one processor; and
at least one memory including computer program code;
the at least one memory and the computer program code configured to, with the at least one processor, cause the apparatus to:
detect a number of received service calls in a predefined time window, the detected service calls being indicative on that service is requested to a floor;
evaluate a number of passengers requesting service based on the received number of service calls in the predefined time window;
select an elevator group among the plurality of the elevator groups to serve the floor, the elevator group being selected based on the evaluated number of passengers requesting service; and
allocate an elevator belonging to the selected elevator group to the floor to provide the service.

9. The apparatus of claim 8, wherein the apparatus is configured to perform the evaluation of the number of passengers requesting the service by:
grouping the received service calls based on a detection that the received service calls comprise at least a common portion in a travel path departing from the floor.

10. The apparatus of claim 9, wherein the apparatus is configured to make a decision of the common portion of the travel path between the service calls based on a direction of a travel indicated in the service calls.

11. The apparatus of claim 8, wherein the apparatus is configured to perform the evaluation of the number of passengers requesting the service by summing up the number of passengers indicated by the number of service calls.

12. The apparatus of claim 8, wherein the apparatus is configured to select the elevator group among the plurality of the elevator groups by matching information indicative of a weight of the evaluated number of passengers with an information on the load unbalance of the elevators of the elevator groups.

13. The apparatus of claim 12, wherein the apparatus is configured to perform the matching by:
comparing information indicative of the weight of the evaluated number of passengers with the information on the load unbalance of the elevators of the elevator groups; and
selecting the elevator group formed by elevators having a load unbalance minimizing a difference in the comparison of information indicative of a weight of the evaluated number of passengers with the information on the load unbalance of the elevators of the elevator groups.

14. (canceled)

15. An elevator system comprising the apparatus according to claim 8.

16. A computer program embodied on a non-transitory computer readable medium and comprising computer readable program code configured to cause an apparatus to perform the method according to claim 1, when said program code is run by the apparatus.

17. The method of claim 2, wherein the evaluation of the number of passengers requesting the service is performed by summing up the number of passengers indicated by the number of service calls.

18. The method of claim 3, wherein the evaluation of the number of passengers requesting the service is performed by summing up the number of passengers indicated by the number of service calls.

19. The method of claim 2, wherein the elevator group is selected among the plurality of the elevator groups by matching information indicative of a weight of the evaluated number of passengers with an information on the load unbalance of the elevators of the elevator groups.

20. The method of claim 3, wherein the elevator group is selected among the plurality of the elevator groups by matching information indicative of a weight of the evaluated number of passengers with an information on the load unbalance of the elevators of the elevator groups.

21. The method of claim 4, wherein the elevator group is selected among the plurality of the elevator groups by matching information indicative of a weight of the evaluated number of passengers with an information on the load unbalance of the elevators of the elevator groups.
